(19) United States
(12) Patent Application Publication
(10) Pub. No.: US 2007/0258268 A1
(43) Pub. Date: Nov. 8, 2007

(54) Optical Sheet and Backlight Assembly Having the Same

(76) Inventors: Cheul Young Kim, Seoul (KR); Sang Mook Kim, Gyeonggi-do (KR); Jong Wook Huh, Gyeonggi-do (KR); Dong Ryoul Kim, Gyeonggi-do (KR); Ju Won Lee, Gyeonggi-do (KR)

Correspondence Address: Jeff Lloyd;Saliwanchik, Lloyd & Saliwanchik, A Professional Association, PO Box 142950, Gainesville, FL, 32614-2950, US

(21) Appl. No.: 11/734,841

(22) Filed: Apr. 13, 2007

(30) Foreign Application Priority Data
May 8, 2006 (KR) 10-2006-41252

(51) Int. Cl. F21V 7/04

(52) U.S. Cl. 362/627

(57) ABSTRACT

Provided are embodiments of an optical sheet and backlight assemblies incorporating the optical sheet. The optical sheet can include a body and a plurality of protrusions. The protrusions are arranged on a surface of the body. A furrow pattern in which furrows are arranged is formed on the protrusion for scattering light.

### CROSS-REFERENCE TO RELATED APPLICATION

The present application claims priority under 35 U.S.C. §119 to Korean Patent Application No. 10-2006-0041252, filed May 8, 2006, which is hereby incorporated by reference in its entirety.

### BACKGROUND

1. Field of the Invention

The present invention relates to an optical sheet and backlight assembly, and more particularly, to optical sheets for enhancing optical characteristics.

2. Description of the Related Art

Unlike other display devices, liquid crystal (LC) molecules interposed between a thin film transistor (TFT) substrate and a color filter substrate of an LCD device are not light-emitting materials emitting light in themselves, but light-receiving materials controlling an amount of light coming from the outside to display an image. Accordingly, the LCD device indispensably requires a separate device for illuminating light onto an LC panel, i.e., a backlight assembly.

A backlight assembly may typically include: a mold frame in which a receiving space is formed; a reflector sheet installed on a lower surface of the receiving space to reflect light to an LC display panel; a light guide plate installed on an upper surface of the reflector sheet to guide light; a lamp unit installed between the light guide plate and lateral walls of the receiving space to emit light; optical sheets stacked on an upper surface of the light guide plate to diffuse and condense light; and a top chassis installed on an upper portion of the mold frame to cover a region ranging from a predetermined location at edges of the LC display panel to a lateral side of the mold frame.

The optical sheets typically may include: a diffusion sheet for diffusing light; a prism sheet stacked on an upper surface of the diffusing sheet to condense diffused light and deliver the condensed light to the LC display panel; and a protection sheet for protecting the diffusion sheet and the prism sheet.

FIG. 1 is a cross-sectional view illustrating a construction of a related art LCD device.

Referring to FIG. 1, the related art LCD device 60 includes a backlight assembly 50 for generating light and a display unit 40 provided on an upper surface of the backlight assembly 50 to receive light from the backlight assembly 50 and display an image.

In detail, the display unit 40 includes the LC display panel 10, and an upper polarizer 30 and a lower polarizer 20 located on an upper surface and a lower surface of the LC display panel 10, respectively. Also, the LC display panel 10 includes a TFT substrate 11 including electrodes, a color filter substrate 12, and an LC layer (not shown) interposed between the TFT substrate 11 and the color filter substrate 12.

The backlight assembly 50 includes a lamp unit 51 for generating light, and a light guide unit for guiding light generated by the lamp unit 51 to an LC display panel 10.

The lamp unit 51 includes a lamp 51a for generating light, and a lamp reflector 51b surrounding the lamp 51a. Light generated by the lamp 51a is incident to a light guide plate 52 of the light guide unit. The lamp reflector 51b reflects light generated by the lamp 51a to the light guide plate 52, thereby increasing an amount of light incident to the light guide plate 52.

The light guide unit includes a reflector 54, the light guide plate 52, and optical sheets 53. The light guide plate 52 is provided on one side of the lamp unit 51 to guide light from the lamp unit 51.

The reflector 54 is provided on a lower surface of the light guide plate 52 to reflect light leaking from the light guide plate 52 back to the light guide plate 52.

In addition, a plurality of optical sheets 53 for enhancing efficiency of light guided by the light guide plate 52 are provided an upper surface of the light guide plate 52. In detail, the optical sheets include a diffusion sheet 53a, a prism sheet 53b, and a protection sheet 53c sequentially stacked on the upper surface of the light guide plate 52.

The diffusion sheet 53a scatters light incident from the light guide plate 52 to make a brightness distribution of light uniform.

The prism sheet 53b has an upper surface in which a triangular prism is repeatedly formed to condense light diffused by the diffusion sheet 53a in a direction perpendicular to a plane of the LC display panel 10. Accordingly, most of light passing through the prism sheet 53b propagates in a direction perpendicular to the plane of the LC display panel 10 to have a uniform brightness distribution.

The protection sheet 53c provided on an upper surface of the prism sheet 53b protects a surface of the prism sheet 53b.

FIG. 2 is a cross-sectional view of the related art prism sheet of FIG. 1, FIG. 3 is a perspective view of the related art prism sheet of FIG. 1, FIG. 4 is a photo of the related art prism sheet of FIG. 1, and FIG. 5 is a photo of the related art diffusion sheet of FIG. 1.

Referring to FIGS. 2 to 5, the related art prism sheet 100 includes a body 110 to which light diffused by the light guide plate and the diffusion sheet is initially provided, and isosceles triangle-shaped protrusions 120 for allowing the diffused light to propagate in a predetermined direction. The protrusions 120 are linearly arranged in stripes on the body 110.

The isosceles triangle prism-shaped protrusions 120 have a pitch of 10-100 μm, and have a characteristic that brightness increases and a viewing angle becomes narrow as an angle α of a vertical angle (generally, an acute angle) of the triangular prism decreases.

The diffusion sheet as shown in FIG. 5 scatters light incident from the light guide plate 52 to make the brightness distribution of light uniform and provide light having the uniform brightness distribution to the prism sheet 100.

Referring to FIGS. 2-4, in the case where the triangular prism-shaped protrusion 120 is formed to face a front side, that is, in the case where the protrusion 120 faces the LC display panel, diffused light introduced via the body 110 is refracted and condensed to the front side, but light incident to an inclined surface of the protrusion cannot contribute to brightness enhancement of the front side due to total internal reflection.

To address this problem, the triangular shape of the prism sheet 100 is formed as an isosceles triangle, or the prism sheet 100 is reversely arranged such that the protrusion of the prism sheet 100 faces the light guide plate as an alternative. However, even in these proposed related arts, it can be very difficult to obtain desirable results in both brightness and viewing angle.

### BRIEF SUMMARY

Accordingly, embodiments of the present invention are directed to an optical sheet and backlight assembly.

Additional features of the invention will be set forth in part in the description which follows and in part will become apparent to those having ordinary skill in the art upon examination of the following or may be learned from practice of the invention. Other advantages of the invention may be realized and attained by the structure particularly pointed out in the written description and claims hereof as well as the appended drawings.

In accordance with the purpose of the invention, as embodied and broadly described herein, there is provided an optical sheet including: a body; and a plurality of protrusions arranged on the body, wherein a furrow pattern is formed in the protrusion.

In another aspect of the present invention, there is provided an optical sheet including: a body to which light is introduced; and a protrusion formed on the body and having at least two surfaces, where at least one surface is rough.

In yet another aspect of the present invention, there is provided an optical sheet for diffusing or condensing moving light, the optical sheet including: a protrusion having a triangular cross-section or a trapezoidal cross-section, wherein an upper surface of the protrusion includes an irregularly formed surface of a predetermined curvature.

In still another aspect of the present invention, there is provided a backlight assembly including: a lamp for generating light; a light guide plate for guiding light generated by the lamp; and an optical sheet disposed on an upper surface of the light guide plate to diffuse or condense the light incident from the light guide plate, wherein the optical sheet has a protrusion disposed in a stripe shape, a furrow pattern in which a plurality of furrows are arranged is formed in an upper surface of the protrusion, and where the furrow pattern can be consecutively disposed in a length direction of the protrusion.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view illustrating a construction of a related art LCD device;

FIG. 2 is a cross-sectional view of the prism sheet according to the related art LCD device illustrated in FIG. 1;

FIG. 3 is a perspective view of the prism sheet according to the related art LCD device illustrated in FIG. 1;

FIG. 4 is a photo of the prism sheet according to the related art LCD device illustrated in FIG. 1;

FIG. 5 is a photo of the diffusion sheet according to the related art LCD device illustrated in FIG. 1;

FIG. 6 is a plan photo of an optical sheet according to an embodiment of the present invention;

FIG. 7 is a partial perspective view for explaining an optical sheet according to an embodiment of the present invention;

FIG. 8 is a cross-sectional view taken along a line 7A-7B of FIG. 7;

FIG. 9 is a cross-sectional view taken along a line 7C-7D of FIG. 7;

FIG. 10 is a view for explaining light refraction at an optical sheet according to an embodiment of the present invention;

FIGS. 11 to 14 are plan photos and cross-sectional photos of optical sheets according to embodiments of the present invention, including a surface having a plurality of furrows;

FIGS. 15 and 16 are graphs comparing optical characteristics depending on a width of a surface in which a plurality of furrows are arranged according to embodiments of the present invention;

FIG. 17 is a partial perspective view for explaining an optical sheet according to an embodiment of the present invention;

FIG. 18 is a cross-sectional view taken along a line 17A-17B of FIG. 17;

FIG. 19 is a view illustrating a construction of a backlight assembly of an LCD device according to an embodiment of the present invention;

FIG. 20 is a view illustrating a construction of a backlight assembly of an LCD device according to an embodiment of the present invention;

FIGS. 21 and 22 are graphs illustrating optical characteristics of the backlight assembly of the LCD device according to an embodiment of the present invention;

FIG. 23 is a view illustrating a construction of a backlight assembly of an LCD device according to an embodiment of the present invention;

FIG. 24 is a view illustrating a construction of a backlight assembly of an LCD device according to an embodiment of the present invention;

FIG. 25 is a view illustrating a construction of a backlight assembly of an LCD device according to an embodiment of the present invention;

FIG. 26 is a view for explaining a method for manufacturing an optical sheet according to an embodiment of the present invention; and

FIG. 27 is a cross-sectional view of a forming mold according to an embodiment of the present invention.

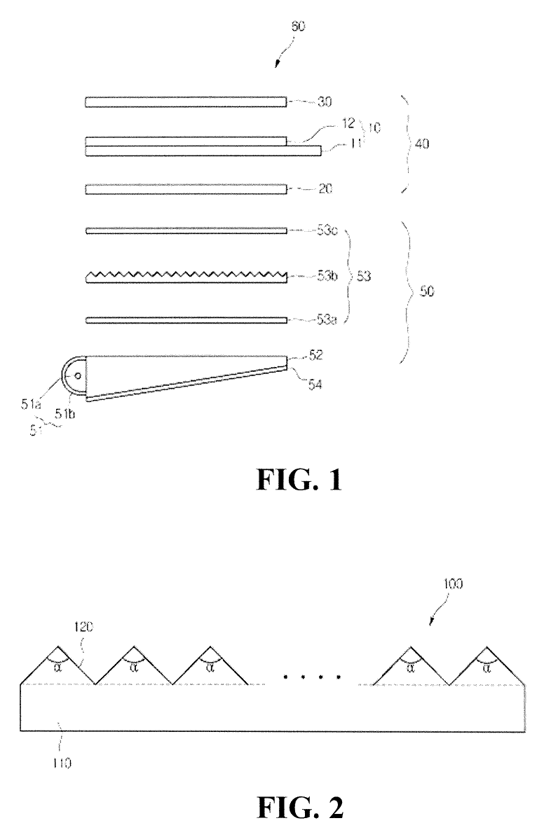

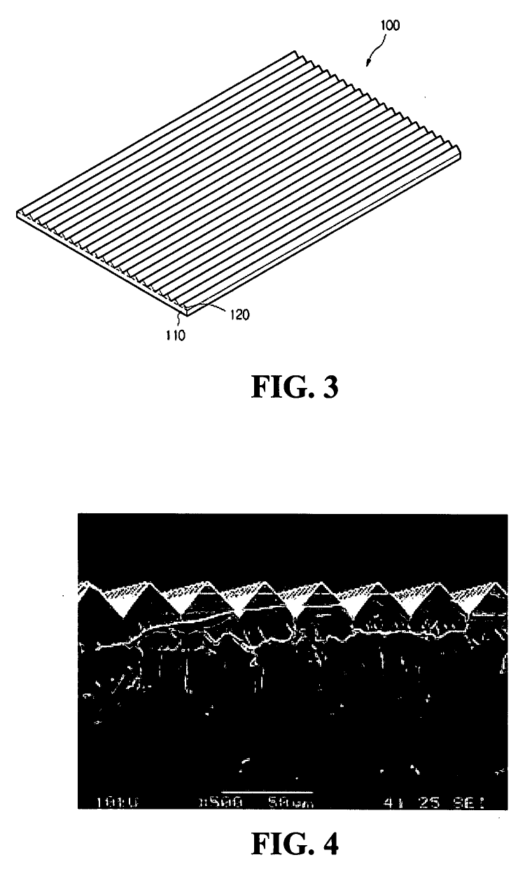

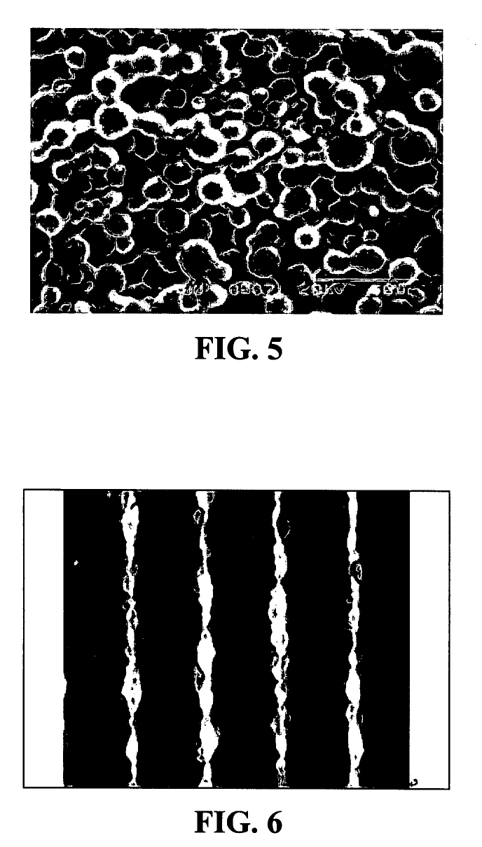

### DETAILED DESCRIPTION

Reference will now be made in detail to the preferred embodiments of the present invention, examples of which are illustrated in the accompanying drawings.

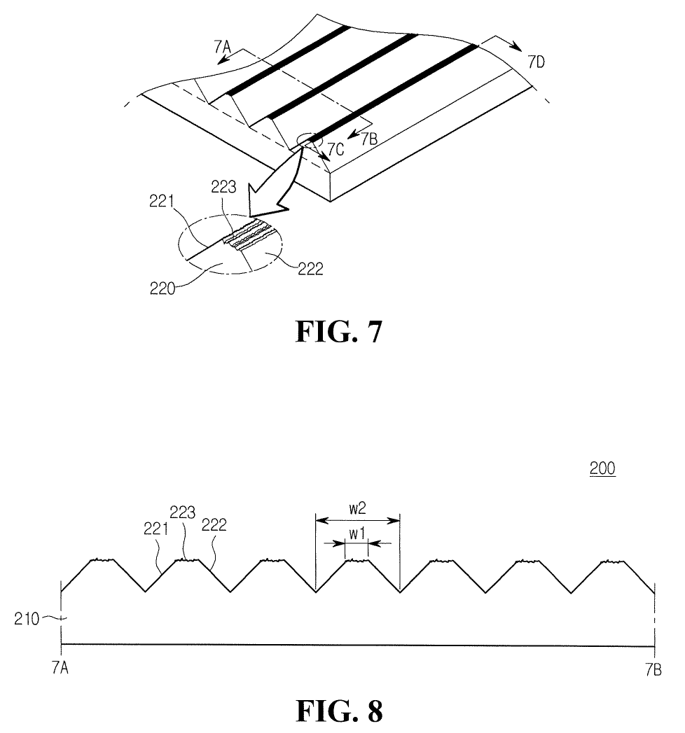

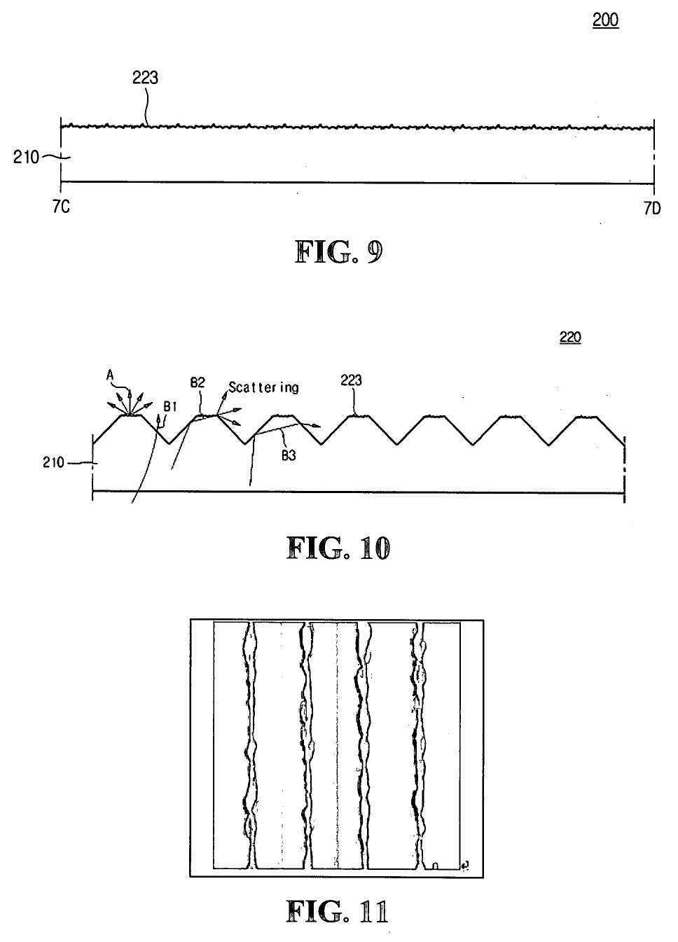

FIG. 6 is a plan photo of an optical sheet according to a first embodiment of the present invention, FIG. 7 is a partial perspective view explaining an optical sheet according to a first embodiment of the present invention, FIG. 8 is a cross-sectional view taken along a line 7A-7B of FIG. 7, and FIG. 9 is a cross-sectional view taken along a line 7C-7D of FIG. 7.

Referring to FIGS. 6 to 9, the optical sheet 200 can include a body 210 having a base and a protrusion 220 integrally formed with the body 210 for diffusing or condensing introduced light.

The protrusion 220 can have an appearance formed by inclined surfaces 221 and 222. In addition, an upper surface of the protrusion 220 can be formed as a rough surface. In a specific embodiment, the rough surface can have a predetermine curvature.

In embodiments, the protrusion 220 can have a triangular or trapezoidal cross-section.

In detail, the protrusion 220 can include a first surface 221 and a second surface 222, and a surface 223 formed on an upper portion of the protrusion having a plurality of furrows for refracting and scattering introduced light. The surface 223 in which the plurality of furrows is arranged can be formed rough because of the formation of predetermined curves, which can be formed regularly or irregularly.

In more detail, a plurality of protrusions 220 can be arranged in stripes on the body 210. A surface, in which a plurality of furrows having a fine size is arranged, can be formed on an upper portion of the protrusion 220. The surface in which the plurality of furrows is arranged is referred to as a ‘furrow pattern 223’.

The furrow pattern 223 can be consecutively formed in a length direction of the protrusion.

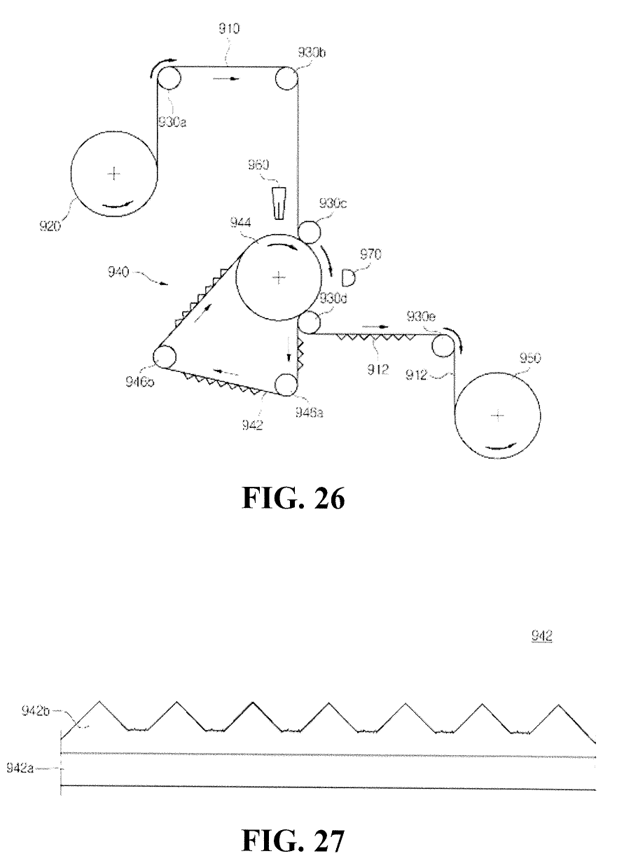

A method for manufacturing the furrow pattern 223 according to an embodiment of the present invention will be described with reference to FIGS. 26 and 27.

The surfaces 221 and 222 constituting the protrusion 220 can be provided in a shape inclined at a predetermined angle with respect to the surface of the body 210. The furrow pattern 223 can be formed in upper portions of the first and second surfaces 221 and 222.

The body 210 can include a plastic film formed of polyethylene terephthalate (PET), polyethylene naphthalate (PEN), aligned polypropylene, polycarbonate, or triacetate, but is not limited thereto.

For example, a polyester film such as a Tetron™ film or a MELINEX™ film can be used as a substrate.

The protrusion 220 can be formed of ultraviolet (UV)-curable acrylate or a thermosetting resin and coated on a surface of the body 210.

The protrusion 220 condenses, diffuses, or reflects light introduced to the body 210. The light condensed or diffused by the protrusion 220 moves to the LC display panel. The light reflected by the protrusion 220 is reflected again by the body 210 or another portion of the protrusion 220, and condensed or diffused through the protrusion 220.

Since optical characteristics of light such as transmittance, brightness, refraction, and diffusion change depending on the shape of the protrusion formed on the optical sheet, the shape of the protrusion 220 of the optical sheet according to a first embodiment of the present invention will be described below.

Referring to FIG. 8, which is a cross-section of FIG. 7 through line 7A-7B, the first surface 221, the furrow pattern 223, and the second surface 222 can be repeatedly formed on the body 210.

Referring to FIG. 9, which is a cross-section of FIG. 7 through line 7C-7D, the furrow pattern 223 can be consecutively formed on the body 210.

The furrow pattern 223 can be formed parallel to a horizontal line, that is, parallel to one surface of the body 210 and has a rough surface. The furrow pattern 223 can have the rough surface with predetermined curves, and can be formed on the first surface 221 and/or the second surface 222.

In a further embodiment, a plurality of protuberances can be formed irregularly in a surface of the furrow pattern 223.

Accordingly, in an embodiment, an optical sheet can include a body 210 and a protrusion 220 formed on the body 210 having at least two surfaces 221 and 222. At least one surface of the protrusion 220 has a rough surface, so that upper portions of the surfaces 221 and 222 have a furrow pattern 223.

FIG. 10 is a view for explaining light refraction at an optical sheet according to a first embodiment of the present invention.

It is known that light incident on a surface of a medium is transmitted or refracted according to the relationship between the incident angle and a critical angle determined by the refractive index of the medium according to optical characteristics at a boundary between media having different refractive indexes.

In this aspect, examination of the optical characteristics of an optical sheet according to the present invention shows that light incident to the furrow pattern 223 is diffused and transmitted. That is, a portion of light having been introduced into the optical sheet according to an embodiment of the present invention moves to the furrow pattern 223 and is scattered and diffused to the LC display panel located above the optical sheet.

In the case where a predetermined defect is present inside an optical sheet, a predetermined dark spot, which is a region where diffusion or condensing of light by refraction of light is not swiftly performed and thus light is not emitted, may be observed. However, in an optical sheet having a furrow pattern 223 according to an embodiment of the present invention, light introduced to the furrow pattern 223 is scattered and emitted by the rough surface of the furrow pattern 223, and accordingly, a defect in the optical sheet can be supplemented.

Referring to FIG. 10, when an incident angle of light incident on the surface of the protrusion 220 according to an embodiment of the present invention is smaller than a critical angle, the light is refracted and emitted at a predetermined angle as illustrated by light B1. Lights B2 and B3 are incident at an angle greater than the critical angle. The light B2 is refracted at the surface of the protrusion 220 and incident to the furrow pattern 223 and scattered. Also, the light B3 is refracted and emitted at the surface of the protrusion 220.

As described above, the furrow pattern 223 formed in the optical sheet according to an embodiment of the present invention increases a light-scattering effect and can supplement a defect that can exist inside the optical sheet.

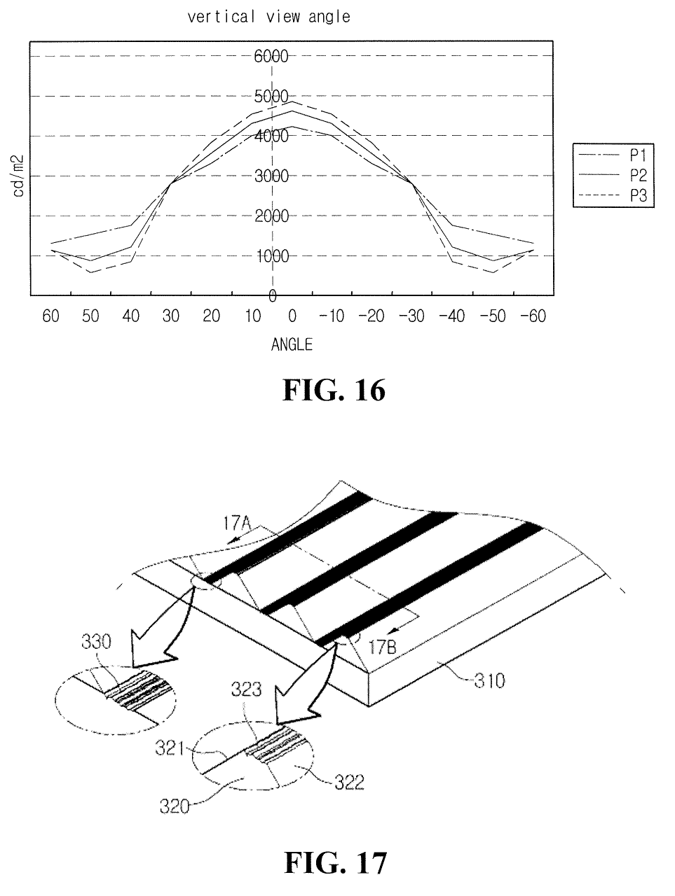

FIGS. 11 to 14 are plan photos and cross-sectional photos of cases where a furrow pattern formed in an optical sheet has different widths according to embodiments of the present invention, and FIGS. 15 and 16 are graphs comparing optical characteristics depending on the width of a furrow pattern according to embodiments of the present invention.

The width ‘w1’ of the furrow pattern 223 and the lower width ‘w2’ of the protrusion 220 illustrated in FIG. 8 are used in explaining FIGS. 11 to 16.

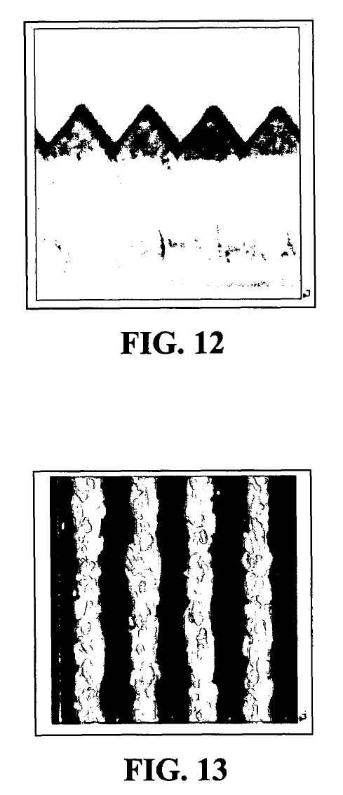

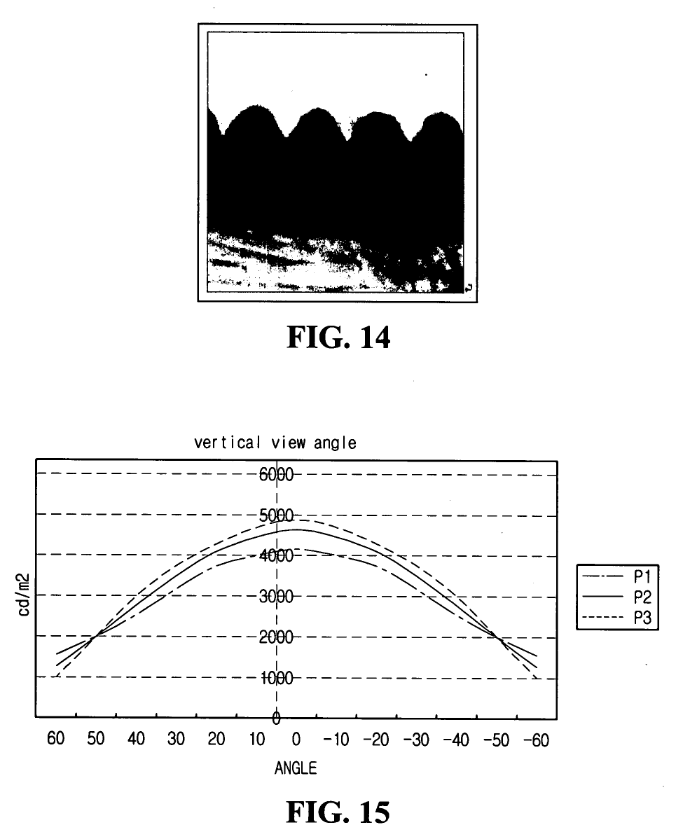

FIGS. 11 and 12 show a plan photo and a cross-sectional photo, respectively, for a case where the furrow pattern 223 has a width ‘w1’ of 3-5 μm, and FIGS. 13 and 14 show a plan photo and a cross-sectional photo, respectively, for a cases where the furrow pattern 223 has a width ‘w1’ of 12-15 μm.

As described above, it can be expected that the optical sheets illustrated in FIGS. 13 and 14 scatter light more than the optical sheets illustrated in FIGS. 11 and 12 in view of the fact that the furrow pattern 223 according to embodiments of the present invention scatters light.

TABLE 1

| | Haze | Transmittance (TLT) | Brightness increase rate |
|---|---|---|---|
| | (back → front) | (back → front) | (gain) |
| P1 | 83 | 50 | 1.32 |
| P2 | 85 | 30 | 1.35 |
| P3 | 88 | 20 | 1.40 |

Table 1 shows measurement results obtained by carrying out an experiment on optical characteristics depending on the width of a furrow pattern in accordance with embodiments of the present invention. In the experiment described in Table 1, P1 is an optical sheet having a furrow pattern with a width ‘w1’ in the range of 12-15 μm, P2 is an optical sheet having a furrow pattern with a width ‘w1’ in the range of 7-10 μm, and P3 is an optical sheet having a furrow pattern with a width ‘w1’ in the range of 3-5 μm.

Optical sheets having a size used for a 17-inch LCD device are used for the experiment, and the distance ‘w2’ between the protrusions is about 25 μm.

The optical sheets illustrated in FIGS. 11 and 13 can be understood to represent P3 and P1, respectively.

Because the furrow pattern according to an embodiment of the present invention has a roughly formed surface on an upper portion of the protrusion, the width ‘w1’ of the furrow pattern may not be maintained constant. Accordingly, the width ‘w1’ of the furrow pattern can be described to have a predetermined range. For example, the width ‘w1’ can be described as 12-15 μm, 3-5 μm, or 7-10 μm according to embodiments of the present invention.

Referring to Table 1, as the width ‘w1’ of the furrow pattern is reduced, that is, the furrow pattern is formed in a decreasing size on the upper portion of the protrusion, haze and brightness increase rate both increase, but transmittance gradually reduces.

That is, according to an embodiment of the present invention, it may be desirable that the furrow pattern has a width ‘w1’ of 3-5 μm in order to enhance brightness of the LCD device even more.

TABLE 2

Viewing angle

| | Horizontal viewing angle | Vertical viewing angle |
|---|---|---|
| P1 | 74 | 100 |
| P2 | 68 | 96 |
| P3 | 64 | 94 |

Table 2 shows results obtained by measuring a viewing angle for optical sheets P1, P2, and P3 used in Table 1.

Referring to Table 2, as the width ‘w1’ of the furrow pattern gradually reduces, that is, the area of the protrusion that is occupied by the furrow pattern gradually reduces, the horizontal viewing angle and the vertical viewing angle become reduced.

Therefore, it may be desirable to use an optical sheet according to an embodiment of the present invention, such as P1 having a width ‘w1’ of 12-15 μm, in order to widen the viewing angle of an LCD device. As described above, it may be desirable to use an optical sheet according to an embodiment of the present invention, such as P3 having a width ‘w1’ of 3-5 μm, in order to enhance the brightness of the LCD device.

FIGS. 15 and 16 show viewing angles and brightness of the optical sheets P1, P2, and P3 used in the above-described experiments. Referring to FIGS. 15 and 16, it appears that P1 is better than P3 in the aspect of a viewing angle, and that P3 is better than P1 in the aspect of brightness.

Detailed numerical values are given by the graphs shown in FIGS. 15 and 16.

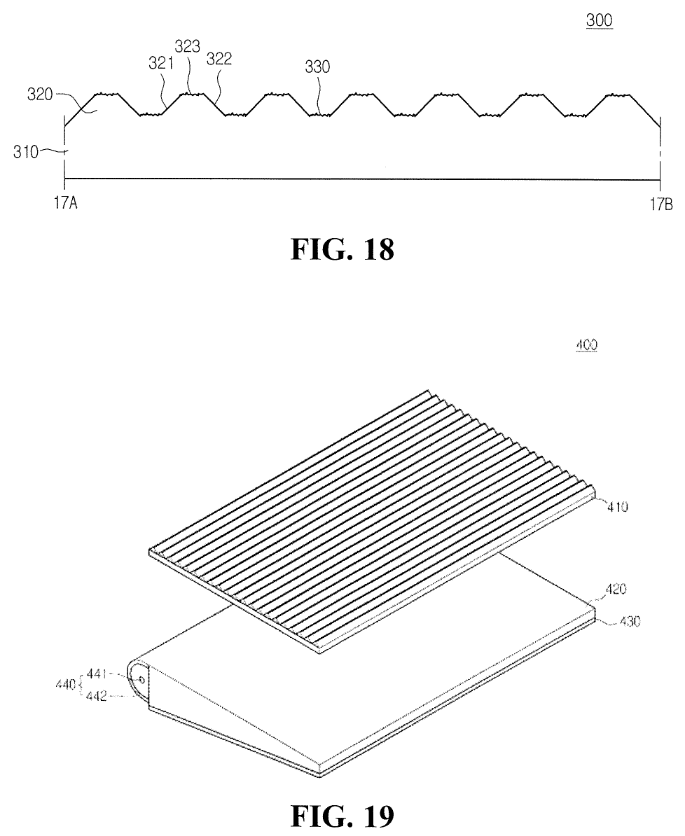

FIG. 17 is a partial perspective view for explaining an optical sheet according to a second embodiment of the present invention, and FIG. 18 is a cross-sectional view taken along a line 17A-17B of FIG. 17.

Referring to FIG. 17, the optical sheet 300 can include a body 310 providing a substrate, and a protrusion 320 that protrudes to a predetermined height on the body 310. Furrow patterns 323 and 330 having the above-described rough surface can be formed on the upper portion of the protrusion 320 and on a predetermined space between protrusions 320.

In detail, the optical sheet 300 can include a plurality of protrusions 320 protruding to a predetermined height on the body 310, where the protrusions 320 are separated a predetermined distance from each other.

Also, a protrusion 320 can include surfaces 321 and 322 inclined at a predetermined angle with respect to the surface of the body 310, and a first furrow pattern 323 formed to a predetermined height of the surfaces 321 and 322, where the first furrow pattern 323 has a rough surface.

A second furrow pattern 330 for increasing a scattering effect of moving light can be formed in a predetermined space between the protrusions 320. The second furrow pattern 330 can be described as being formed in a portion of the surface of the body 310.

The cross-section observed along a line 17A-17B of FIG. 17 shows that the first furrow pattern 323 and the second furrow pattern 330 are repeatedly formed on the body 310 as illustrated in FIG. 18.

Referring to FIG. 18, the cross-section of the optical sheet according to the second embodiment of the present invention includes the second furrow pattern 330 formed in a surface of the body 310, the first surface 321 of the protrusion 310, the first furrow pattern 323 formed on the upper portion of the first surface 321 and the second surface 322, and the second surface 322 of the protrusion 320 repeatedly formed.

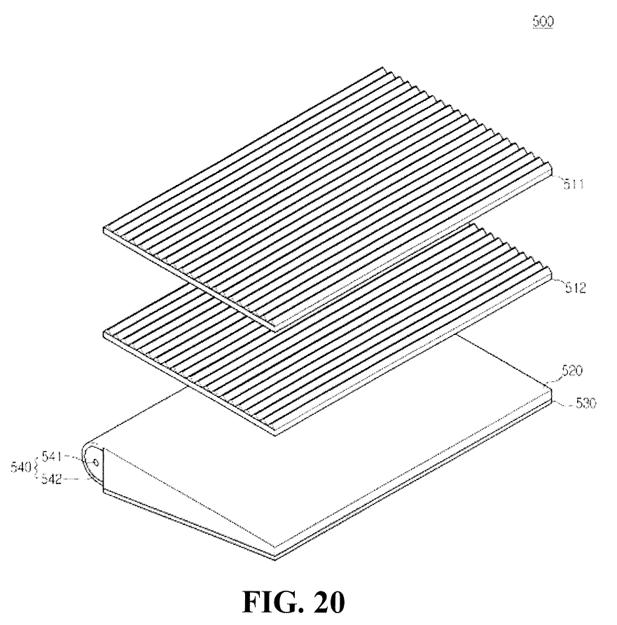

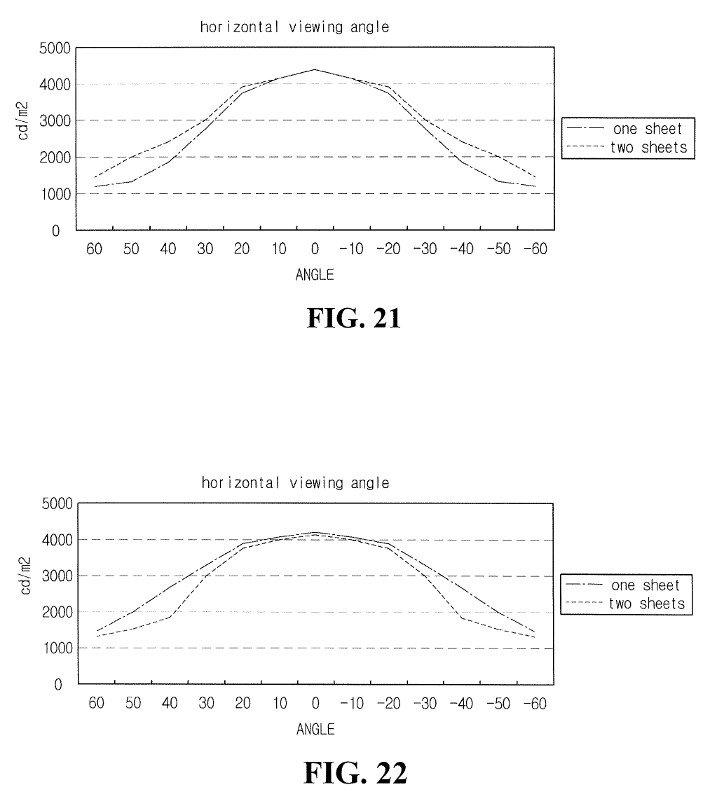

FIG. 19 is a view illustrating a construction of a backlight assembly of an LCD device according to an embodiment of the present invention, FIG. 20 is a view illustrating a construction of a backlight assembly of an LCD device according to another embodiment of the present invention, and FIGS. 21 and 22 are graphs illustrating optical characteristics of the backlight assembly of the LCD device according to embodiments of the present invention.

First, referring to FIG. 19, a backlight assembly 400 of the LCD device can include a lamp unit 440 for generating light, and a light guide unit for guiding the light generated by the lamp unit 440 to an LC display panel.

The lamp unit 440 can include a lamp 441 for generating light, and a lamp reflector 442 surrounding the lamp 441. The light generated by the lamp 441 is incident to a light guide plate 420 of the light plate.

The lamp reflector 442 reflects light generated by the lamp 441 to the light guide plate 420, thereby increasing an amount of light incident to the light guide plate 420.

Also, the light guide unit according to an embodiment of the present invention can include a reflector 430, the light guide plate 420, and an optical sheet 410. The optical sheet 410 may be an optical sheet according to the first embodiment or the second embodiment as described with respect to FIGS. 7 and 17, respectively. FIG. 22 illustrates an optical sheet according to the first embodiment of the present invention, but an optical sheet according to the second embodiment can also be used.

The light guide plate 420 can be provided on one side of the lamp unit 440 to guide the light generated from the lamp unit 440 to the LC display panel.

The reflector 430 can be provided on a lower surface of the light guide plate 420 to reflect light leaking from the light guide plate 420 back to the light guide plate 420.

An optical sheet 410 for enhancing optical characteristics of the light guided by the light guide plate 420 can be provided at an upper surface of the light guide plate 420.

Referring to FIG. 20, a backlight assembly 500 of an LCD device according to an embodiment of the present invention can include a lamp unit 540 for generating light, and a light guide unit for guiding the light generated by the lamp unit 540 to an LC display panel. The lamp unit 540 can include a lamp 541 for generating light, and a lamp reflector 542 for surrounding the lamp 541. Also, the light guide unit can include a light guide plate 520 to which the light generated from the lamp 541 is incident, and a reflector 530 for reflecting the light leaking from the light guide plate 520 back to the light guide plate 520.

In this embodiment, two optical sheets 511 and 512 according to the first embodiment or the second embodiment of the present invention as shown in FIGS. 7 and 17, respectively, can be stacked on the light guide plate 520.

FIGS. 21 and 22 are graphs showing results of carrying out experiments regarding a viewing angle and brightness of the backlight assembly of the LCD device according to an embodiment of the present invention. The optical sheets used in the experiments for FIGS. 21 and 22 are configured as optical sheet P3 used in the previously described experiments.

The graphs regarding experiment results shown in FIGS. 21 and 22 are given brief in Table 3 below.

TABLE 3

| | Brightness |
|---|---|
| | increase rate (gain) |
| One sheet P3 | 1.40 |
| Two sheets P3 | 1.43 |
| Diffusion sheet + BEF ™ + | 1.40 |
| protection sheet | |

Table 3 shows a brightness increase rate for the case where one P3 optical sheet whose furrow pattern has a width ‘w2’ of 3-5 μm is used, a brightness increase rate for the case where two P3 optical sheets are used, and a brightness increase rate for the case where a diffusion sheet+a BEF™+a protection sheet are used.

Here, the combination of the diffusion sheet+the BEF™+the protection sheet denotes optical sheets used for a related art backlight assembly. The BEF™ is a prism sheet by 3M Co.

The measurement results show brightness for the case where one optical sheet according to an embodiment of the present invention is used is 1.40, and brightness for the case where two optical sheets according to an embodiment of the present invention is used is 1.43, which is relatively greater.

Also, it is revealed that the case where one optical sheet according to an embodiment of the present invention is used shows almost the same brightness increase rate as that of the case where the diffusion sheet and the protection sheet are used together with the prism sheet by 3M Co.

That is, even in the case where only one optical sheet according to an embodiment of the present invention is used, a brightness increase similar to a brightness increase of the case where related art three sheets of the diffusion sheet, the prism sheet, and the protection sheet are used can be obtained. Furthermore, in the case where two optical sheets according to an embodiment of the present invention are used, greater brightness increase rate can be obtained.

TABLE 4

Viewing angle

| | Horizontal | Vertical |
|---|---|---|
| | viewing angle | viewing angle |
| One sheet P3 | 94 | 64 |
| Two sheets P3 | 87 | 70 |
| Diffusion sheet + BEF ™ + | 95 | 65 |
| protection sheet | | |

Table 4 shows a viewing angle for the case where a P3 optical sheet is used, a viewing angle for the case where two P3 optical sheets are used, and a viewing angle for the case where related art diffusion sheet and protection sheet are used together with the prism sheet by 3M Co.

Measurement results show a horizontal viewing angle for the case where two optical sheets according to an embodiment of the present invention are used is relatively smaller than a horizontal viewing angle for the case where one optical sheet according to an embodiment of the present invention is used. However, a vertical viewing angle for the case where two optical sheets are used is relatively greater than a vertical viewing angle for the case where one optical sheet is used.

On the other hand, in the case where the diffusion sheet, the protection sheet, and the prism sheet are used, a horizontal viewing angle is widest but is not greatly different from a horizontal viewing angle for the case where one diffusion sheet according to an embodiment of the present invention is used.

Also, a vertical viewing angle for the case where one optical sheet according to an embodiment of the present invention is used is not greatly different from a vertical viewing angle for a related art case.

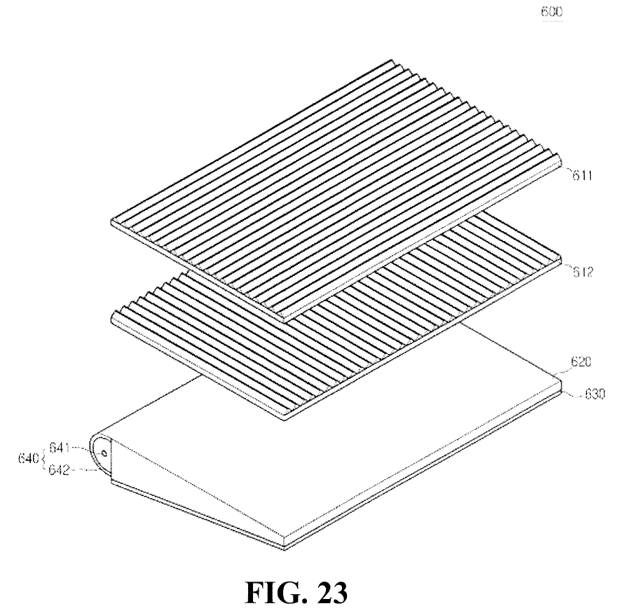

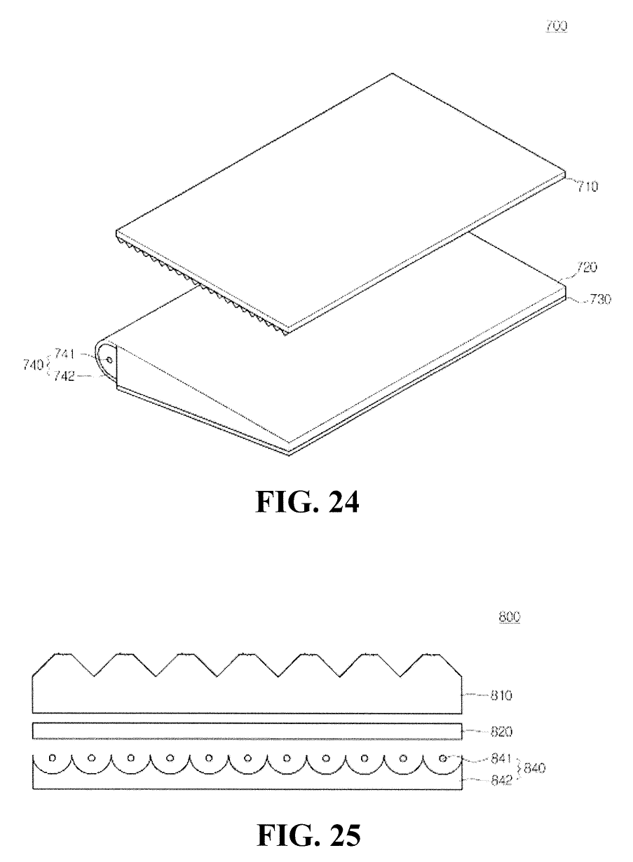

FIG. 23 is a view illustrating a construction of a backlight assembly of an LCD device according to a third embodiment of the present invention, and FIG. 24 is a view illustrating a construction of a backlight assembly of an LCD device according to a fourth embodiment of the present invention.

The backlight assembly 600 of an LCD device according to the third embodiment of the present invention can include a lamp unit 640 for generating light, and a light guide unit for guiding the light generated by the lamp unit 640 to an LC display panel. The lamp unit 640 can include a lamp 641 for generating light, and a lamp reflector 642 surrounding the lamp 641. The light guide unit can include a light guide plate 620 to which the light generated from the lamp 641 is incident, and a reflector 630 for reflecting the light leaking from the light guide plate 620 back to the light guide plate 620.

Two optical sheets 611 and 612 formed according to the first embodiment or the second embodiment as shown in FIGS. 7 and 17, respectively, can be stacked on the light guide plate 620. The optical sheets 611 and 612 can be arranged such that furrow patterns formed in protrusions of the optical sheets 611 and 612 cross each other.

That is, as shown in FIG. 23, the optical sheets 611 and 612 can be stacked to cross each other such that lines formed by the furrow patterns of the optical sheets cross each other. Two optical sheets formed according to the first embodiment or the second embodiment as shown in FIGS. 7 and 17, respectively, can be used where one of the two optical sheets is rotated by 90° with respect to the other optical sheet.

In another embodiment, referring to FIG. 24, a backlight assembly 700 of an LCD device according to a fourth embodiment of the present invention can include a lamp 741 for generating light, a lamp reflector 742 surrounding the lamp 741, a light guide plate 720 to which the light generated by the lamp 741 is incident, and a reflector 730 for reflecting the light leaking from the light guide plate 720 back to the light guide plate 720.

An optical sheet 710 formed according to the first or second embodiment as shown in FIGS. 7 and 17, respectively, can be disposed on the upper surface of the light guide plate 720.

Particularly, the optical sheet 710 is disposed such that the protrusion faces the light guide plate 720. Light that has passed through the light guide plate 720 is not incident to a body first, but incident to the protrusion and a furrow pattern formed in the optical sheet 710, and then emitted through the body.

Also, although not shown, a related art diffusion sheet, prism sheet, or protection sheet can be further provided in the backlight assembly.

However, since the optical sheet alone according to an embodiment of the present invention can sufficiently perform the function of the related art diffusion sheet or prism sheet, an excellent effect can be obtained in aspects of a viewing angle and brightness using the optical sheet of the present invention alone.

FIG. 25 is a view illustrating a construction of a backlight assembly of an LCD device according to a fifth embodiment of the present invention.

Referring to FIG. 25, the backlight assembly 800 can include a lamp unit 840 for generating light and a diffusion unit for guiding the light generated by the lamp unit 840 to an LC display panel.

The lamp unit 840 can include a lamp 841 for generating light, and a lamp reflector 842 surrounding the lamp 841. The light generated by the lamp 841 is incident on the light guide plate 820. For reference, the light guide plate 820 may also be called a diffusion plate, but is referred to as a light guide plate in this description.

The lamp reflector 842 reflects the light generated by the lamp 841 to the light guide plate 820 to increase an amount of the light incident to the light guide plate 820.

The diffusion unit includes the light guide plate 820 and an optical sheet 810. The light guide plate 820 is disposed on the upper surface of the lamp unit 840 to diffuse the light generated from the lamp unit 840 and guide the diffused light to an LC display panel.

Because the light guide plate 820 is disposed on the upper surface of the lamp unit 840, the light leaking from the light guide plate 820 can be introduced back to the light guide plate 820 by the lamp reflector 842.

Also, the optical sheet 810, which increases the optical efficiency of light directed by the light guide plate 820, can be disposed on the upper surface of the light guide plate 820. The optical sheet 810 can be an optical sheet formed according to the first or second embodiment as shown in FIGS. 7 and 17, respectively.

FIG. 26 is a view for explaining a method for manufacturing an optical sheet according to an embodiment of the present invention, and FIG. 27 is a cross-sectional view of a forming mold according to an embodiment of the present invention.

First, referring to FIG. 26, an apparatus for manufacturing an optical sheet according to an embodiment of the present invention can include a first roll 920 on which a base film 910 is wound a second roll 950 on which an optical sheet 912 in which a pattern is formed is wound, and guide rolls 930a to 930e for transferring the base film 910 and the optical sheet 912 in which the pattern has been formed through the apparatus.

The guide rolls can include a first guide roll 930a, a second guide roll 930b, a third guide roll 930c, a fourth guide roll 930d, and a fifth guide roll 930e. The number and positions of the guide rolls can change depending on modifications to the apparatus.

The apparatus for manufacturing the optical sheet can further include a pattern molding unit 940 provided, for example, between the third guide roll 930c and the fourth guide roll 930d to coat a patterned coating solution on the base film 910. The pattern molding unit 940 can serve as a pattern roll.

In detail, the pattern molding unit 940 can include: a forming mold 942 having a pattern shape; a drum roll 944 for allowing an injected coating solution to stick on the forming mold 942, to pattern the coating solution using the pattern provided to the forming mold 942, and coat the patterned coating solution onto the base film 910; and pattern guide rolls 946a and 946b for transferring the forming mold 942 about the pattern molding unit 940.

The forming mold 942 can be formed in a belt type by coating a patterned layer on a base layer of a film shape. Like the above-described pattern roll, the forming mold 942 patterns the coating solution.

Although FIG. 26 shows that a portion of the pattern has been realized on the pattern layer of the forming mold 942, the pattern can be realized an entire forming mold when it is actually formed.

The forming mold 942 can be installed by surrounding an extending line connecting the drum roll 944 with the pattern guide rolls 946a and 946b using the forming mold 942 and connecting both ends of the forming mold 942.

Because a joint formed by connecting both ends of the forming mold 942 can have a remarkably longer period than that of a joint of a related art pattern roll, a period of a pattern defect generated at a joint portion can also be lengthened, so that yield of a completed optical sheet 912 can be improved.

It can be sufficient to form the forming mold 942 longer and form a longer interval between the drum roll 944 and the pattern guide rolls 946a and 946b in order to lengthen the period of the joint.

The apparatus for manufacturing an optical sheet according to an embodiment of the present invention can further include a coating solution injecting element 960 for injecting a coating solution to a region inserted into the pattern molding unit 940, and a curing element 970 for applying heat or illuminating ultraviolet (UV) to cure the coating solution.

An operation of an apparatus for manufacturing an optical sheet according to an embodiment of the present invention will be described below.

The base film 910 wound on the first roll 920 can be transferred towards the second roll 950 by the guide rolls 930a to 930e. In addition, the forming mold 942 provided to the pattern molding unit 940 can be transferred about the pattern molding unit 940 and rotated by being wound on the drum roll 944 and the pattern guide rolls 946a and 946b.

Also, since the drum roll 944 can be engaged with the third guide roll 930c and the fourth guide roll 930d, the base film 910 can contact the forming mold 942 through the third guide roll 930c.

Here, the third guide roll 930c can perform a gap control function of controlling the thickness of the coating solution coated on the base film 910 for controlling the thickness of the pattern layer of a completed optical sheet.

In detail, when the third guide roll 930c is closely attached on the drum roll 944, the thickness of the pattern layer of the optical sheet becomes thin. On the other hand, when the third guide roll 930c is separated apart from the drum roll 944, the thickness of the pattern layer of the optical sheet becomes thicker. The thickness of the pattern layer (e.g., a protrusion) of the optical sheet can be controlled using viscosity of the coating solution, pattering speed, and tensile force of the base film in addition to the interval between the third guide roll 930c and the drum roll 944.

The coating solution can be injected by the coating solution injecting element 960 to a predetermined region where the base film 910 is inserted between the third guide roll 930c and the drum roll 944. The coating solution is pushed into a space between the pattern of the forming mold 942 and fills the pattern.

Also, the coating solution can be uniformly distributed on the base film 910 by the pressure between the third guide roll 930c and the drum roll 944, so that pattern forming occurs. The coating solution distributed between patterns can then be cured using heat or UV emitted from the curing element 970.

The base film 910 on which the pattern-formed coating solution is cured and coated can be separated from the forming mold 942 while it is drawn out by the fourth guide roll 930d. The completed optical sheet 912 can be transferred by the fifth guide roll 930e and wound on the second roll 950.

Here, the fourth guide roll 930d separates the optical sheet 912 on which the coating solution has been coated from the forming mold 942. In other words, the fourth guide roll 930d separates the optical sheet 912 on which the pattern layer has been formed from the forming mold 942.

The above-described base film 910 and completed optical sheet 912 according to the above described embodiment of the present invention denote the same element, and their names are classified depending on whether the coating solution has been coated or not.

That is, the base film 910 means a state before the pattern is formed, and the optical sheet 912 means a state where the pattern-formed coating solution is coated on the base film while it passes through the pattern molding unit 940.

Also, although FIG. 26 shows a portion of the pattern layer formed on the optical sheet 912, the pattern layer is also formed on the optical sheet wound on the second roll 950.

FIG. 27 shows a forming mold according to an embodiment of the present invention for use in forming a pattern in the coating solution using the coating solution injecting element. The forming mold can be formed in a flexible film shape where a pattern shape has been realized in a resin formed of high polymer.

The forming mold can have a two-story structure of a base layer 942a having a continuous flat surface of a relatively uniform thickness, and a pattern layer 942b including a fine shape carved on at least one surface of the base layer 942a. The pattern layer 942b should be provided in a shape reverse to the pattern of the optical sheet to be manufactured.

In this case, the pattern layer 942b illustrated in FIG. 27 can be used for manufacturing an optical sheet according to the first embodiment of the above-described optical sheets as shown in FIG. 7. A rough surface corresponding to the furrow pattern of the optical sheet can be formed in a predetermined region of the pattern layer 942b.

The base layer 942b of the forming mold 942 can be formed of a transparent and flexible film having predetermined tensile strength and durability. In a specific embodiment, the base layer 942b can be formed of a polyethyleneterephthalate (PET).

In an embodiment, the resin material constituting the pattern layer 942b can be a mixture of high polymer such as oligomer and curing start agent.

The various embodiments of the present invention can obtain excellent effects in aspects of optical characteristics such as brightness and a viewing angle.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An optical sheet, comprising:
a body; and
protrusions arranged on the body,
wherein a furrow pattern is formed in the protrusions.

2. The optical sheet according to claim 1, wherein the furrow pattern is formed on an upper surface of the protrusions.

3. The optical sheet according to claim 2, wherein the furrow pattern is further formed on a surface between the protrusions.

4. The optical sheet according to claim 1, wherein the furrow pattern comprises a plurality of irregularly arranged furrows.

5. The optical sheet according to claim 1, wherein the furrow pattern is disposed in a length direction of the protrusions.

6. An optical sheet, comprising:
a body for which light is introduced; and
a protrusion protruding to a predetermined height on the body,
wherein a furrow pattern for scattering light is formed in the protrusion.

7. An optical sheet, comprising:
a body for which light is introduced; and
a protrusion formed on the body and having at least two surfaces,
wherein at least one surface is rough.

8. The optical sheet according to claim 7, wherein the protrusion comprises two inclined surfaces and a furrow pattern in which a plurality of furrows are arranged at upper portions of the two surfaces.

9. The optical sheet according to claim 7, wherein the protrusion is arranged in stripes along a surface of the body at predetermined intervals, and a surface of the body located between the protrusions has a furrow pattern in which a plurality of furrows are formed.

10. The optical sheet according to claim 7, wherein the protrusion and the body are integrally formed.

11. The optical sheet according to claim 7, wherein a cross-section of the protrusion is a triangular shape or a trapezoidal shape.

12. An optical sheet for diffusing or condensing moving light, the optical sheet comprising:
a protrusion having a triangular cross-section or a trapezoidal cross-section,
wherein an upper surface of the protrusion comprises an irregularly formed surface of a predetermined curvature.

13. A backlight assembly comprising:
a lamp for generating light;
a light guide plate for guiding the light generated by the lamp; and
an optical sheet disposed on an upper surface of the light guide plate to diffuse or condense the light incident from the light guide plate,
wherein the optical sheet comprises a body and a protrusion protruding to a predetermined thickness from one side of the body, wherein the protrusion has a furrow pattern whose surface is formed rough.

14. A backlight assembly comprising:
a lamp for generating light;
a light guide plate for guiding the light generated by the lamp; and
an optical sheet disposed on an upper surface of the light guide plate to diffuse or condense the light incident from the light guide plate,
wherein the optical sheet has a protrusion disposed in a stripe shape, a furrow pattern in which a plurality of furrows are arranged formed in an upper surface of the protrusion, and where the furrow pattern is consecutively disposed in a length direction of the protrusion.

15. The backlight assembly according to claim 14, wherein the furrow pattern scatters light moving from the light guide plate.

16. The backlight assembly according to claim 14, further comprising a second or more optical sheet.

17. The backlight assembly according to claim 14, wherein the protrusion is disposed in a direction facing light moving from the light guide plate.
